(19) United States
(12) Patent Application Publication
(10) Pub. No.: US 2004/0266539 A1
(43) Pub. Date: Dec. 30, 2004

(54) Laser staked two-piece drive shaft for a starter motor

(75) Inventors: Ron Gentry, Cicero, IN (US); Ken E. Rummel, Greenfield, IN (US); Rich VanSickle, Noblesville, IN (US)

Correspondence Address: Thomas A. Walsh, Ice Miller, One American Square, Box 82001, Indianapolis, IN, 46282-0002, US

(73) Assignee: Delco Remy America, Inc., a Delaware corporation, Anderson, IN

(21) Appl. No.: 10/873,918

(22) Filed: Jun. 22, 2004

Related U.S. Application Data
(60) Provisional application No. 60/483,385, filed on Jun. 27, 2003.

(51) Int. Cl. F16C 3/00

(52) U.S. Cl. 464/182

(57) ABSTRACT

A drive shaft assembly for an electromechanical apparatus is disclosed that possesses increased and long-lasting torque strength. The drive shaft assembly comprises a drive shaft that is inserted into an aperture in a plate via a cold staking process such that the outer surface of the drive shaft is in contact with an inner edge of the plate to form a frictional engagement. The drive shaft is then joined to the inner edge of the plate by laser welding, which serves to produce a rigid connection.

### RELATED PATENT APPLICATION

This patent application claims the benefit of U.S. Provisional Patent Application No. 60/483,385, LASER STAKE TWO-PIECE DRIVE SHAFT FOR A STARTER MOTOR, filed Jun. 27, 2003, and assigned to the same assignee as the present invention.

### BACKGROUND OF THE INVENTION

Starter motors typically include a drive shaft assembly wherein a drive shaft 20 is connected to a starter motor plate 10, as shown in FIGS. 1, 2, and 3. Drive shaft 20 has a stake end 22 and an opposite end 24. Stake end 22 includes a shoulder 26 formed between a larger diameter portion 27 and a smaller diameter portion 25, and a helical spline gear 32 is formed upon drive shaft 20 near stake end 22. A central bore 28 is formed in stake end 22 that is used for a bushing, which typically contains lubricating oil. Drive shaft 20 forms a rim 50 around central bore 28 in stake end 22; this is best seen in FIG. 3. Further, as shown in FIG. 3, starter motor plate 10 includes serrations (e.g., a series of knurls) 40 on an inner edge 70 that define an aperture in plate 10. Rim 50 of drive shaft 20 presses against, and is frictionally engaged with, knurls 40. Starter motor plate 10 also holds a plurality of pins 30 located between inner edge 70 and an outer edge 80 that extend perpendicularly from the bottom surface of plate 10. Pins 30 are used to retain planet gears (not shown) that mesh with a sun gear (not shown) on an adjoining shaft (not shown).

As shown in FIGS. 1, 2, and 3, starter motor plate 10 is joined to stake end 22 of drive shaft 20. The top surface of starter motor plate 10 faces drive shaft 20 and abuts shoulder 26 of drive shaft 20. The bottom surface of starter motor plate 10 faces away from drive shaft 20 and is positioned flush with or extends beyond stake end 22 of drive shaft 20.

The typical connection between a drive shaft and starter motor plate is produced by “cold staking” starter motor plate 10 onto drive shaft 20. During the “cold staking” process, as shown in FIG. 4, a staking press presses starter motor plate 10 onto stake end 22 of drive shaft 20 such that drive shaft 20 is inserted into the aperture of starter motor plate 10 defined by inner edge 70. As described above and shown in FIG. 2, the top surface of starter motor plate 10 abuts shoulder 26 of drive shaft 20, and, as described above and shown in FIG. 3, knurls 40 frictionally engage with drive shaft 20. The resulting frictional engagement between rim 50 and knurls 40 provides a rigid connection between starter motor plate 10 and drive shaft 20 that is intended to be capable of withstanding the torque necessary to start an engine.

A drive shaft assembly according to the prior art proves to be problematic when used in large vehicles, such as those containing large diesel engines. Large diesel engines require more torque than typical car engines in order to be started. Over time, the high levels of torque placed on drive shaft 20 can cause the connection between drive shaft 20 and starter motor plate 10 to slip, i.e., the frictional engagement between rim 50 and knurls 40 is overcome. When starter motor plate 10 slips relative to drive shaft 20, the starter motor may not transmit the appropriate torque to the engine, and the engine may be prevented from starting.

Prior attempts at creating a drive shaft assembly with increased and long-lasting torque strength have involved welding starter motor plate 10 to drive shaft 20 using traditional welding techniques. However, when the welding tool contacts starter motor plate 10 to perform such a weld, the heat from the welding tool is conducted through plate 10 causing pins 30 on plate 10 to shift, or causing plate 10 to slightly warp. Proper orientation and positioning of pins 30 are essential to provide for proper retention of planet gears and, in turn, the smooth meshing thereof with a sun gear on a shaft adjoining the drive shaft. Thus, it would be desirable to create a drive shaft assembly that possesses increased torque strength, and that can meet the prolonged, high torque demands of a large engine, e.g., a diesel engine. The desired drive shaft is produced in a manner that does not deform starter motor plate 10, or distort the positioning or the orientation of pins 30 on starter motor plate 10.

### BRIEF SUMMARY OF THE INVENTION

The subject invention relates to a drive shaft assembly for an electromechanical apparatus. In an exemplary embodiment, the subject invention comprises a plate, which has a first and second parallel surface, an outer edge, and an aperture through the plate the boundary of which defines an inner edge. The inner edge of the plate contains serrations, which are a series of knurls. The drive shaft assembly also contains a shaft, which has a longitudinal axis, a stake end, and an opposite end, with the stake end being inserted along its longitudinal axis into the aperture of the plate. The shaft has a shaft circumference about the longitudinal axis that defines a rim. This rim is sized such that when the shaft is inserted into the aperture of the plate, portions of the shaft rim are in contact with portions of the inner edge of the plate to form a frictional engagement. The inner edge of the plate and the shaft are joined by a weld that is produced by a laser welding process in which a laser beam is aimed at and makes contact with the shaft rim.

In an exemplary embodiment, the subject invention comprises a method for assembling a drive shaft assembly comprising the steps of pressing a plate onto the stake end of a shaft along its longitudinal axis under mechanical pressure, such that the shaft is inserted into the aperture of the plate and portions of the rim are in contact with portions of the inner edge of the plate to form a frictional engagement, and then joining the shaft rim to the inner edge of the plate by laser welding. The laser beam from a laser welding device contacts the rim of the shaft. In an aspect of this embodiment, the laser beam is delivered at an angle with the longitudinal axis of the shaft of about 7.5 degrees, while the laser welding device is powered at about 1850 Watts, thereby melting the rim metal, which flows between the rim of the shaft and the inner edge of the plate. Laser welding provides a rigid connection between the shaft and the plate, thereby providing increased and long-lasting torque strength for the drive shaft assembly.

### BRIEF DESCRIPTION OF THE DRAWINGS

The features and advantages of this invention, and the manner of attaining them, will be more apparent and better understood by reference to the following descriptions of exemplary embodiments of the invention, taken in conjunction with the accompanying drawings, wherein:

FIG. 1 shows a side perspective view of a drive shaft assembly according to the prior art wherein a drive shaft has been “cold staked” to a knurled, starter motor plate;

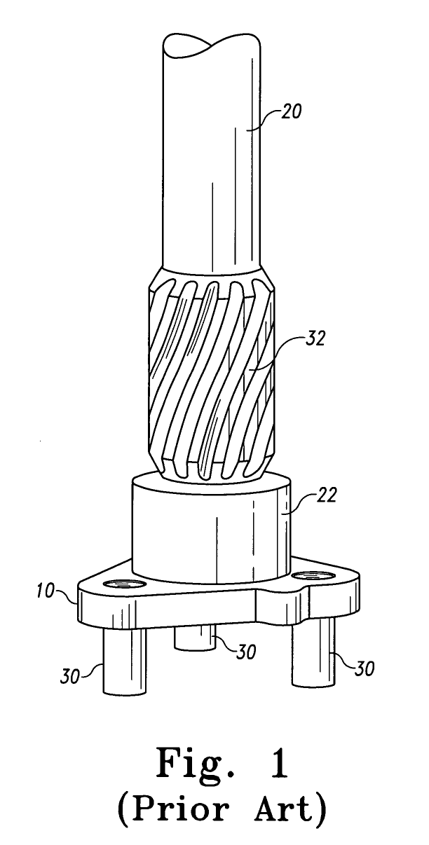

FIG. 2 shows a partial cross-sectional view of the prior art drive shaft assembly of FIG. 1;

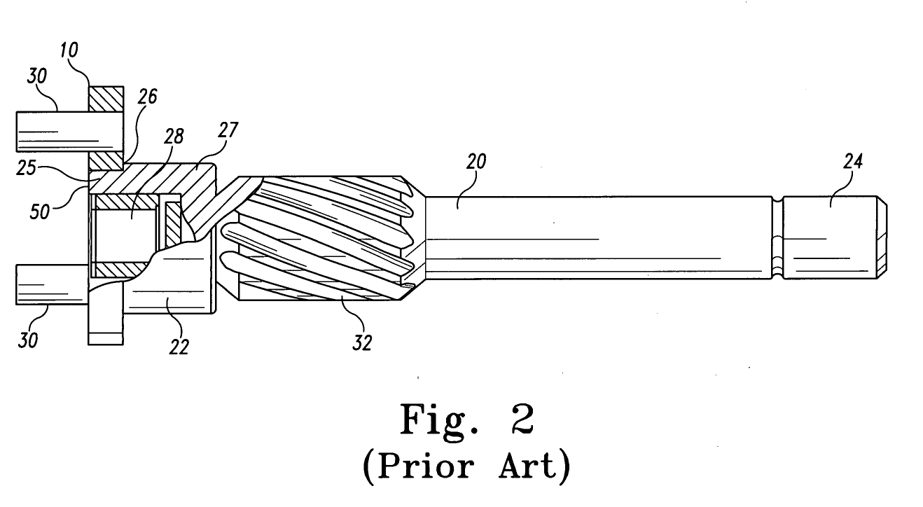

FIG. 3 shows an end view of the prior art drive shaft assembly of FIG. 1;

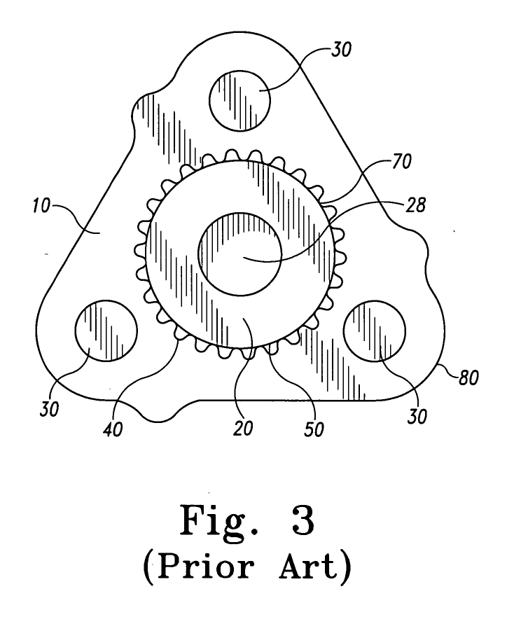

FIG. 4 shows a diagram of the prior art “cold staking” process;

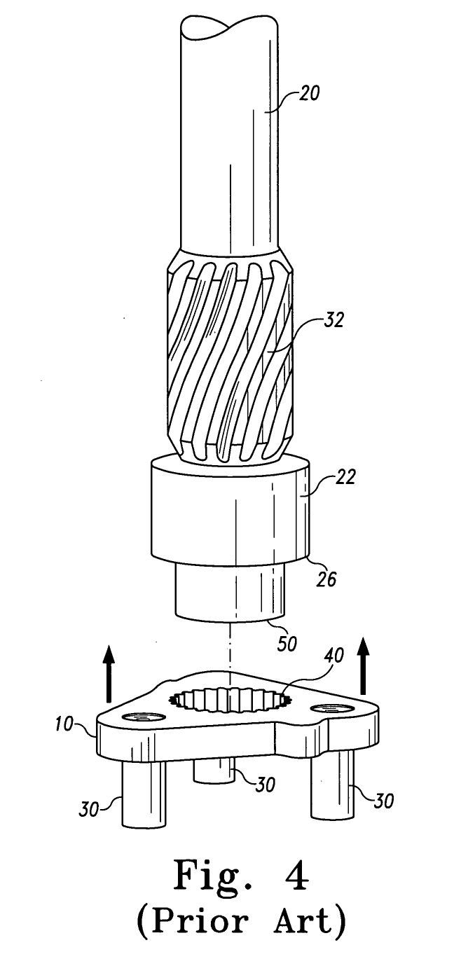

FIG. 5 shows an end view of a drive shaft assembly wherein a drive shaft has been laser staked to a knurled, starter motor plate according to the subject invention;

FIG. 6 shows an exemplary laser staking setup according to the subject invention for laser staking a drive shaft and a knurled, starter motor plate; and

FIG. 7 shows a chart of the laser stake cycle schedule according to the subject invention showing laser power vs. time.

### DETAILED DESCRIPTION OF THE INVENTION

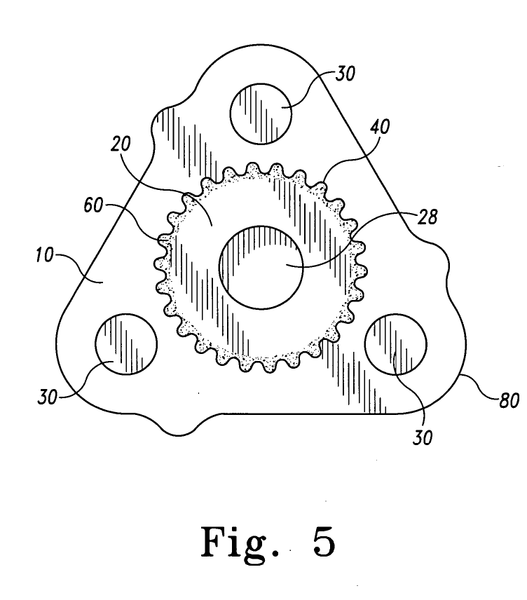

The subject invention relates to a drive shaft assembly for an electromechanical apparatus that possesses increased and long-lasting torque strength. FIG. 5 shows an exemplary embodiment of the subject invention. As shown in FIG. 5, this embodiment comprises a two-piece drive shaft assembly wherein drive shaft 20 is laser staked to starter motor plate 10.

The drive shaft assembly of the exemplary embodiment of the subject invention, shown in FIG. 5, is made by first utilizing a “cold stake” process discussed above to connect drive shaft 20 to starter motor plate 10 by means of a frictional engagement between rim 50 and knurls 40. After drive shaft 20 is “cold staked” to starter motor plate 10, a laser welding device is used to weld rim 50 of drive shaft 20 to knurls 40 of plate 10, thereby producing weld 60 between drive shaft 20 and knurls 40.

In order to accomplish this weld, a laser beam from a laser welding device contacts rim 50 of drive shaft 20 and travels all or substantially all of the circumference of rim 50. This process melts the metal comprising rim 50 so that rim 50 metal flows around, into, and between knurls 40 around the circumference of drive shaft 20. During this welding process, the laser beam does not contact starter motor plate 10, but, rather, only contacts rim 50 of drive shaft 20. Rim 50 of drive shaft 20 may comprise a material, layer, coating, or member that facilitates completion of weld 60.

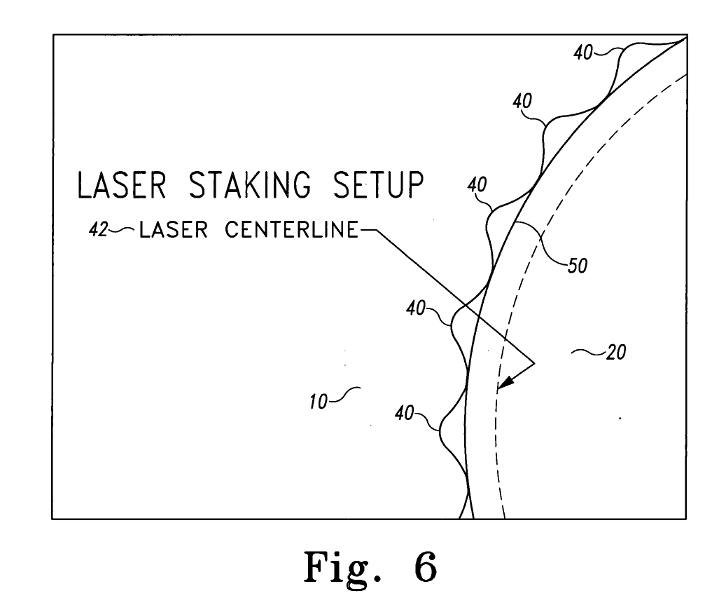

An exemplary embodiment of a laser welding setup is shown in FIG. 6. In particular, the laser beam centerline 42 in this exemplary embodiment is shown within rim 50 of drive shaft 20 and removed from knurls 40 of starter motor plate 10; the laser welded surface of rim 50 of drive shaft 20 being substantially coplanar to the top surface of starter motor plate 10. The laser beam has a nominal beam width “D” in the focal area. The nominal beam width D normally ranges from between about 0.050 in. to about 0.060 in. The centerline 42 of the laser beam is ½D from the edge of rim 50. Thus, to assure that laser beam 50 impinges only on rim 50, the laser beam is aimed so that it traverses along a centerline 42 that is at least ½D within the edge of rim 50.

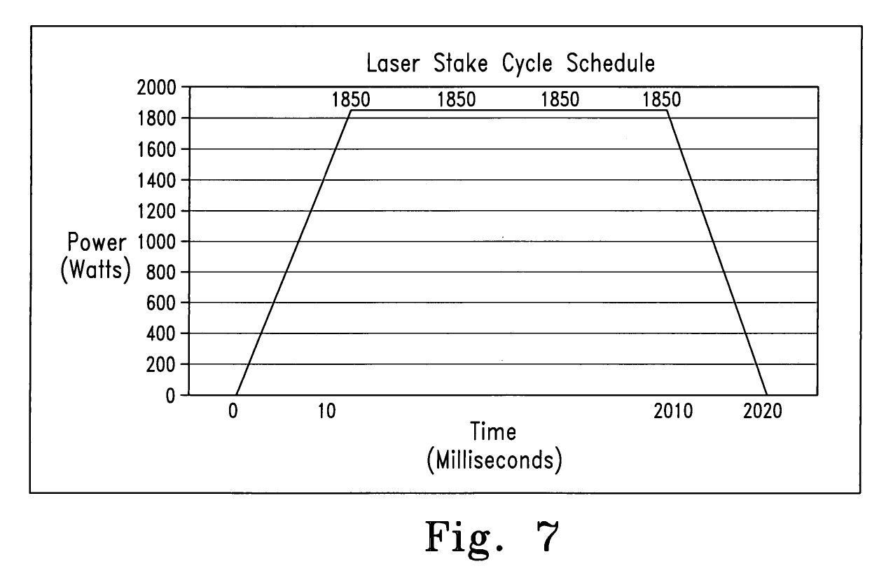

In an exemplary embodiment of the subject invention, the laser welding device power is ramped up gradually from 0 to 1850 Watts over a period of 0-10 milliseconds (“ms”), as shown in FIG. 7. The laser welding device remains powered at 1850 Watt from the 10 ms mark until the 2010 ms mark in the welding process as the laser beam travels around rim 50 of drive shaft 20. From the 2010 ms mark, the laser welding device is powered down from 1850 to 0 Watts over a period of 10 ms. The total weld time is approximately 2020 ms. In one embodiment, the laser beam is aligned such that it forms an angle of about 7.5 degrees with the longitudinal axis of drive shaft 20. In an embodiment, the laser welding device has a 150 mm focal length with a parabolic reflective optics. In an embodiment, a cover gas of Nitrogen or Argon may be used to provide an inert environment for weld 60. In an embodiment, the laser beam is focused at a depth of at least about 2.5 mm below the surface of drive shaft 20.

The subject invention provides a rigid, laser welded connection, weld 60, between starter motor plate 10 and drive shaft 20, the result of which is a drive shaft assembly that is better able to withstand and deliver torque without slippage between starter motor plate 10 and drive shaft 20. Further, because the laser beam from a laser welding device does not contact starter motor plate 10, i.e., contact is made only with rim 50 of drive shaft 20 according to the subject invention, plate 10 does not overheat or deform. Thus, proper orientation and positioning of pins 30 are maintained.

Although the laser staked, two-piece drive shaft assembly of the subject invention has been described in considerable detail with reference to particular exemplary embodiments thereof, other versions are possible. For example, drive shaft 20 and starter motor plate 10 may take any number of different forms and include a number of different elements, depending upon the particular configuration of the starter motor. In addition, the drive shaft assembly of the subject invention may also be utilized in other electromechanical apparati, such as alternators and generators. Therefore, the spirit and scope of the appended claims should not be limited to the description of the embodiments described herein.

We claim:

1. A drive shaft assembly for an electromechanical apparatus, the drive shaft assembly comprising:
a plate having first and second parallel surfaces, a outer edge, and an aperture through said plate, said aperture having a boundary defining an inner edge of said plate; and
a shaft having a longitudinal axis, a stake end, and an opposite end, said stake end being inserted into said aperture; and
a weld joining said shaft to said inner edge of said plate, said weld being produced by a laser welding process wherein a laser beam is aimed at said shaft to form said weld.

2. The drive shaft assembly of claim 1, wherein the electromechanical apparatus is a starter motor, an alternator, or a generator.

3. The drive shaft assembly of claim 1, wherein said stake end is frictionally engaged with said inner edge of said plate.

4. The drive shaft assembly of claim 1, wherein said inner edge of said plate comprises knurls.

5. The drive shaft assembly of claim 1, wherein said stake end of said shaft comprises a shoulder formed between a larger diameter portion of said stake end and a smaller diameter portion of said stake end, said shoulder abutting said first surface of said plate.

6. The drive shaft assembly of claim 1, wherein said stake end of said shaft has a central bore formed therein.

7. The drive shaft assembly of claim 6, wherein said central bore comprises a bushing.

8. A method of assembling a drive shaft assembly from a shaft and a plate, the shaft having a longitudinal axis, a stake end, and an opposite end, the plate having first and second parallel surfaces, a outer edge, and an aperture through said plate, wherein the aperture has a boundary defining an inner edge of said plate, the method comprising the steps of:
inserting said stake end into said aperture; and
welding said shaft to said inner edge of said plate, said welding being accomplished by a laser welding process wherein a laser beam is aimed at said shaft.

9. The method of claim 8, wherein said inserting step comprises the step of:
applying mechanical pressure to said plate, said mechanical pressure being applied substantially in the direction of said longitudinal axis of said shaft.

10. The method of claim 8, wherein said welding step comprises the step of:
melting a surface of said shaft.

11. The method of claim 8, wherein said welding step comprises the step of:
causing a substance to flow between said shaft and said inner edge of said plate.

12. The method of claim 8, wherein said laser beam has a beam width D, and wherein said welding step comprises the step of:
applying said laser beam along a centerline positioned at least about ½D from said inner edge of said plate.

13. The method of claim 8, wherein said welding step comprises the step of:
aligning said laser beam such that said laser beam and said longitudinal axis form an angle of about 7.5 degrees.

14. The method of claim 8, wherein said welding step comprises the step of:
generating said laser beam such that said laser beam has power of at least about 1850 Watts.

15. In a drive shaft assembly of the type comprising a plate and a shaft, wherein the shaft is frictionally engaged with an aperture in the plate such that the longitudinal axis of the shaft is substantially perpendicular to a plane formed by a surface of said plate, an improvement comprising:
a weld joining said shaft to said plate, said weld being produced by a laser welding process wherein a laser beam is aimed at said shaft to form said weld.

16. The drive shaft assembly of claim 15, wherein the drive shaft assembly is a component of an electromechanical apparatus.

17. The drive shaft assembly of claim 15, wherein said aperture is bounded by a knurled edge.

18. The drive shaft assembly of claim 15, wherein said stake end of said shaft comprises a shoulder formed between a larger diameter portion of said stake end and a smaller diameter portion of said stake end, said shoulder abutting said first surface of said plate.

19. The drive shaft assembly of claim 15, wherein said stake end of said shaft has a central bore formed therein.
